(19) United States
(12) Patent Application Publication
(10) Pub. No.: US 2019/0347395 A1
(43) Pub. Date: Nov. 14, 2019

(54) VERIFICATION METHOD BASED ON DOUBLE FINGERPRINT RECOGNITION, MOBILE TERMINAL, AND STORAGE DEVICE

(71) Applicant: HUIZHOU TCL MOBILE COMMUNICATION CO., LTD., HUIZHOU (CN)

(72) Inventor: TINGTING CHAO, HUIZHOU (CN)

(21) Appl. No.: 16/520,378

(22) Filed: Jul. 24, 2019

Related U.S. Application Data
(63) Continuation of application No. PCT/CN2018/097396, filed on Jul. 27, 2018.

(30) Foreign Application Priority Data
Jul. 28, 2017 (CN) 201710627619.9

(51) Int. Cl. G06F 21/32; G06K 9/00; H04M 1/02

(52) U.S. Cl. CPC G06F 21/32; H04M 1/026; G06K 9/00926; G06K 9/00087

(57) ABSTRACT

The present disclosure provides a verification method based on double fingerprint recognition, a mobile terminal, and a storage device, which include: acquiring fingerprints of two fingers of a user in advance, by fingerprint recognition buttons on both sides of a mobile terminal, and generating a verification data template of the two fingerprints according to a preset algorithm; acquiring fingerprints of two fingers of a user, and generating a data template according to the preset algorithm; matching the data template with the verification data template, and when the matching is successful, prompting information that a fingerprint verification operation is passed and executing the corresponding operation instructions.

### CROSS-REFERENCE TO RELATED APPLICATIONS

The present application is a continuation-application of International (PCT) Patent Application No. PCT/CN2018/097396, filed on Jul. 27, 2018, which claims foreign priority of Chinese Patent Application No. 201710627619.9, filed on Jul. 28, 2017 in the China National Intellectual Property Administration, the entire contents of which are hereby incorporated by reference.

### FIELD

The described embodiments relate to a mobile terminal fingerprint verification application technology, and more particularly, to a verification method based on double fingerprint recognition, a mobile terminal, and a storage device.

### BACKGROUND

Electronic payment is becoming more and more popular, and the electronic device payment is very popular among users. While electronic devices bring convenience and speed, there are also major security risks, so that how to ensure the security of electronic devices is worth considering.

Currently, encryption technologies used in electronic devices basically have passwords, gestures, and fingerprints. Passwords and gestures are closely related to people's subjectivity. They can be deciphered through certain operations. Fingerprints are human biological characteristics, and a security factor is higher than passwords and gestures.

Currently, there are two types of fingerprint recognition modules on the electronic device. One is below the front side of the electronic device, generally is at a home button position, and the other is behind the rear side of the electronic device, generally is below the rear camera. Such the type on the front side of the electronic device occupies a position of the screen, so that the screen ratio of the electronic device is reduced. Therefore, in some full-screen electronic devices, the second type is adopted. The fingerprint recognition module is arranged on the rear side, but it cannot be designed into a convex shape. It is not easy for the user to find the location of the fingerprint recognition, which is inconvenient for the user to use.

Therefore, the related art has yet to be improved and developed.

### SUMMARY

A technical problem to be solved by the present disclosure is to provide a verification method based on double fingerprint recognition, a mobile terminal, and a storage device. By arranging respectively fingerprint verification chips on frames of left and right sides of an electronic device, a position of a screen does not be occupied on a front side of the electronic device. A situation that a user cannot find a position of the fingerprint recognition arranged on a rear side of the electronic device, is avoided. The screen ratio of the electronic device is increased, and security of the electronic device is increased by the verification of double fingerprints.

In order to solve the above-mentioned technical problem, a technical solution adopted by the present disclosure is to provide a storage device.

The storage device includes program data stored in the storage device, and the program data is configured to be executed to perform operations in the following blocks.

Block A, fingerprints of two fingers of a user is acquired in advance, by fingerprint recognition buttons on both sides of a mobile terminal, and a verification data template of the two fingerprints is generated according to a preset algorithm.

Block B, when the mobile terminal operates fingerprint recognition and receives an instruction of a fingerprint verification operation, fingerprints of two fingers of a user is acquired, and a data template is generated according to the preset algorithm.

Block C, the data template is matched with the verification data template, and when the matching is successful, information that the fingerprint verification operation is passed is prompted, and the corresponding operation instructions are executed.

The fingerprints acquired by the fingerprint recognition buttons are different.

In order to solve the above-mentioned technical problem, a technical solution adopted by the present disclosure is to provide a verification method based on double fingerprint recognition, including operations in the following blocks.

Block A, fingerprints of two fingers of a user is acquired in advance, by fingerprint recognition buttons on both sides of a mobile terminal, and a verification data template of the two fingerprints is generated according to a preset algorithm.

Block B, when the mobile terminal operates fingerprint recognition and receives an instruction of a fingerprint verification operation, fingerprints of two fingers of a user is acquired, and a data template is generated according to the preset algorithm.

Block C, the data template is matched with the verification data template, and when the matching is successful, information that the fingerprint verification operation is passed is prompted, and the corresponding operation instructions are executed.

In order to solve the above-mentioned technical problem, a technical solution adopted by the present disclosure is to provide a mobile terminal, including fingerprint recognition buttons on both sides of the mobile terminal, configured to acquire and identify fingerprints of two fingers of a user; a processor; and a memory communicatively coupled to the processor; wherein the memory stores a computer program; and the processor is configured to invoke the computer program in the memory to perform the following operations: acquiring fingerprints of two fingers of a user in advance, by the fingerprint recognition buttons on the both sides of the mobile terminal, and generating a verification data template of the two fingerprints according to a preset algorithm; when the mobile terminal operates fingerprint recognition and receives an instruction of a fingerprint verification operation, acquiring fingerprints of two fingers of a user, and generating a data template according to the preset algorithm; matching the data template with the verification data template, and when the matching is successful, prompting information that the fingerprint verification operation is passed and executing the corresponding operation instructions.

The present disclosure provides a verification method based on double fingerprint recognition, a mobile terminal, and a storage device, which include: acquiring fingerprints of two fingers of a user in advance, by fingerprint recognition buttons on both sides of a mobile terminal, and generating a verification data template of the two fingerprints according to a preset algorithm; acquiring fingerprints of two fingers of a user, and generating a data template according to the preset algorithm; matching the data template with the verification data template, and when the matching is successful, prompting information that the fingerprint verification operation is passed and executing the corresponding operation instructions. By arranging respectively fingerprint verification chips on frames of left and right sides of an electronic device, a position of a screen does not be occupied on a front side of the electronic device. A situation is avoided that a user cannot find a position of the fingerprint recognition arranged on a rear side of the electronic device. The screen ratio of the electronic device is increased, and security of the electronic device is increased by the verification of double fingerprints.

### BRIEF DESCRIPTION OF THE DRAWINGS

FIG. 1 is a flow chart of a verification method based on double fingerprint recognition with an embodiment in the present disclosure.

FIG. 2 is a flow chart of a verification method based on double fingerprint recognition with a specific embodiment in the present disclosure.

FIG. 3 is a structural illustration of positions of double fingerprint recognition buttons with an embodiment in the present disclosure.

FIG. 4 is a functional block diagram of a mobile terminal of the present disclosure.

### DETAILED DESCRIPTION

The detailed description set forth below is intended as a description of the subject technology with reference to the appended figures and embodiments. It is understood that the embodiments described herein include merely some parts of the embodiments of the present disclosure, but do not include all the embodiments.

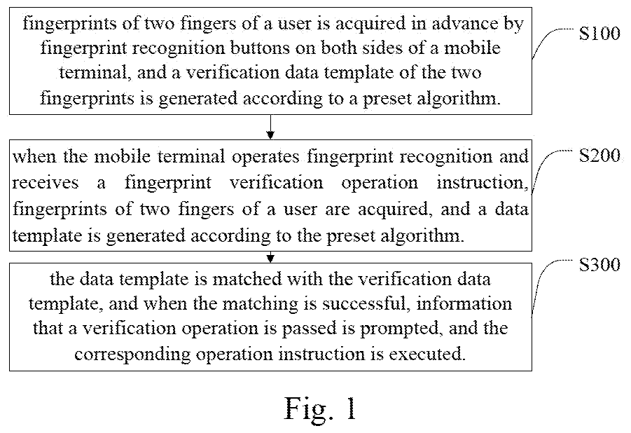

A verification method based on double fingerprint recognition with an embodiment in the present disclosure, refers to FIG. 1. The verification method based on double fingerprint recognition, includes operations in the following blocks.

Block S100, fingerprints of two fingers of a user is acquired in advance by fingerprint recognition buttons on both sides of a mobile terminal, and a verification data template of the two fingerprints is generated according to a preset algorithm.

The improvement of the present disclosure is that two fingerprint recognition buttons are arranged at positions on both sides of a mobile terminal, instead of being a lower side of the front of the mobile terminal or a top side of the rear of the mobile terminal. In the fingerprint recognition buttons, as shown in FIG. 1, a button 1 is a mobile terminal power button, a button 3 is a volume adjustment button, a button 2 is a fingerprint recognition button X, and a button 4 is a fingerprint recognition button Y.

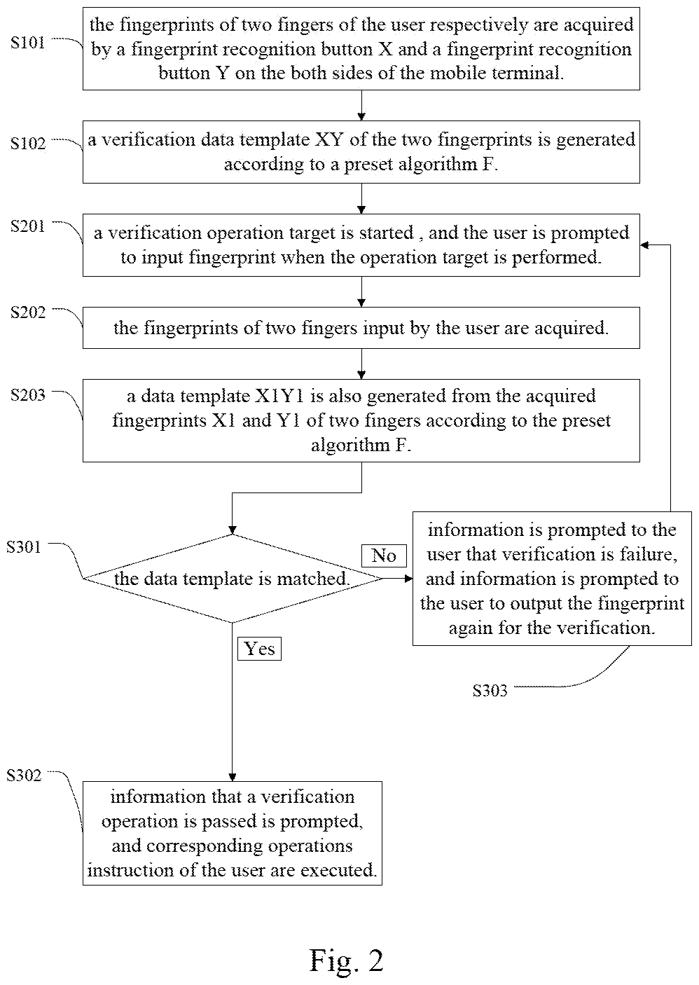

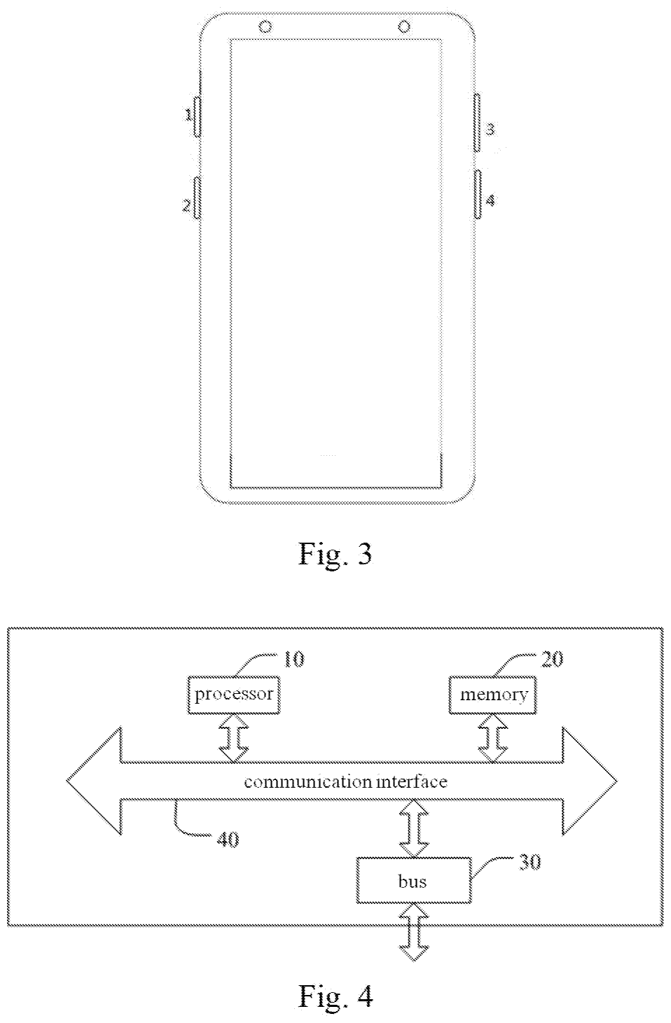

In a specific implementation, as shown in FIG. 2, block S100 includes operations in the following blocks.

Block S101, the fingerprints of two fingers of the user respectively are acquired by a fingerprint recognition button X and a fingerprint recognition button Y on the both sides of the mobile terminal.

Block S102, a verification data template XY of the two fingerprints is generated according to the acquired fingerprints of two fingers by a preset algorithm F, and the verification data template XY is stored in a memory of the mobile terminal, wherein the verification data template XY is configured to match for the fingerprint recognition.

Further, in an actual operation, the fingerprint recognition button X and the fingerprint recognition button Y on the both sides of the mobile terminal acquire fingerprints of two fingers of a user. The fingerprint may on any finger (generally the thumb and the forefinger in a same hand). The fingerprints acquired by the fingerprint recognition button X and the fingerprint recognition button Y are different. The fingerprint verification data template XY of the two fingerprints acquired multiple times, is generated according to the preset algorithm F and stored in the memory of the mobile terminal. The fingerprint verification data template XY is configured to match for the fingerprint recognition. The reason for adding fingerprint acquiring and fingerprint recognition, is to increase the security of the fingerprint recognition.

Block S200, when the mobile terminal operates fingerprint recognition and receives an instruction of a fingerprint verification operation, fingerprints of two fingers of a user are acquired, and a data template is generated according to the preset algorithm.

In a specific implementation, as shown in FIG. 2, block S200 includes operations in the following blocks.

Block S201, a verification operation target configured to operate the fingerprint recognition in the mobile terminal is started in advance, and the user is prompted to input fingerprint when the operation target is performed.

Block S202, when the instruction of the fingerprint verification operation is received, the fingerprints of two fingers input by the user are acquired.

Block S203, a data template X1Y1 is generated from the acquired fingerprints X1 and Y1 of two fingers according to the preset algorithm F.

Further, in an actual operation, the instruction of the fingerprint verification operation is started in the mobile terminal. The user is prompted to input fingerprint information when performing the fingerprint verification operation. The fingerprint information of the user is acquired by the fingerprint recognition button X and the fingerprint recognition button Y on the both sides of the mobile terminal. After the fingerprint information is acquired, the data template X1Y1 is generated according to the preset algorithm F. The data template X1Y1 is configured to match the fingerprint verification data template XY stored in the memory.

Block S300, the data template is matched with the verification data template, and when the matching is successful, information that the fingerprint verification operation is passed is prompted, and the corresponding operation instructions are executed.

In addition, when the matching the data template with the verification data template is failed, information is prompted to the user that the fingerprint verification operation is failure, and information is prompted to the user to input the fingerprint again for the fingerprint verification operation.

In a specific implementation, as shown in FIG. 2, block S300 includes operations in the following blocks.

Block S301, the data template X1Y1 generated by the preset algorithm F, is matched with the verification data template XY.

Block S302, when the matching is successful, information that the fingerprint verification operation is passed is prompted, and the corresponding operation instructions of the user are executed.

Block S303, when the matching is failed, information is prompted to the user that the fingerprint verification operation is failure, and information is prompted to the user to input the fingerprint again for the fingerprint verification operation.

Further, in an actual operation, when the data template X1Y1 is matched with the verification data template XY, just in case where the fingerprint recognition on both sides of the mobile terminal is passed, the fingerprint verification operation that is passed is indicated, and information that the fingerprint verification operation is passed is prompted to the user, and the corresponding operation instructions of the user are executed. It is mainly used for electronic payment of mobile terminals, such as verification by WeChat, Alipay, and the like. It is also used for encryption for software used in mobile terminals, such as encryption of photos, and the like. When the matching is failed, information is prompted to the user that the fingerprint verification operation is failure, and returning to block S200 to perform the fingerprint recognition again. For example, when a fingerprint of a user's finger is not clear such as situations that a hand is sweating or there is water on a hand, the matching may fail multiple times. When a number that the matching fails, reaches a preset number (for example, 3 times, which may be set according to the user's request), current operations is disabled for a preset time (for example, 1 hour), and until the fingerprint recognition is operated again after the preset time.

The present disclosure further provides a mobile terminal as shown in FIG. 4. The mobile terminal further includes a processor 10, a memory 20, a communication interface 30, and a bus 40.

The processor 10, the memory 20, and the communication interface 30 complete communications with each other through the bus 40.

The communication interface 30 is configured to transmit information between communication devices of the mobile terminal.

The processor 10 is configured to invoke the computer program in the memory 20 to perform the method provided by the above-mentioned embodiments. For example, the method includes: acquiring fingerprints of two fingers of a user in advance, by the fingerprint recognition buttons on the both sides of the mobile terminal, and generating a verification data template of the two fingerprints according to a preset algorithm; when the mobile terminal operates fingerprint recognition and receives an instruction of a fingerprint verification operation, acquiring fingerprints of two fingers of a user, and generating a data template according to the preset algorithm; matching the data template with the verification data template, and when the matching is successful, prompting information that the fingerprint verification operation is passed and executing the corresponding operation instructions.

The present disclosure further provides a storage device. The storage device includes program data stored in the storage device. The program data is configured to be executed to implement the verification method based on double fingerprint recognition.

In summary, the present disclosure provides a verification method based on double fingerprint recognition, a mobile terminal, and a storage device, which include: acquiring fingerprints of two fingers of a user in advance, by fingerprint recognition buttons on both sides of a mobile terminal, and generating a verification data template of the two fingerprints according to a preset algorithm; acquiring fingerprints of two fingers of a user, and generating a data template according to the preset algorithm; matching the data template with the verification data template, and when the matching is successful, prompting information that the fingerprint verification operation is passed and executing the corresponding operation instructions. By arranging respectively fingerprint verification chips on frames of left and right sides of an electronic device, a position of a screen does not be occupied on a front side of the electronic device. A situation is avoided that a user cannot find a position of the fingerprint recognition arranged on a rear side of the electronic device. The screen ratio of the electronic device is increased, and security of the electronic device is increased by the verification of double fingerprints.

Certainly, those skilled in the art may understand that all or part of the processes in the foregoing embodiments, may be implemented by a computer program to instruct related hardware (such as a processor, a controller, and the like). The program may be stored in a computer readable storage medium, and the program may include the flow of the method in above-mentioned embodiments when executed. The storage medium described therein may be a memory, a magnetic disk, an optical disk, or the like.

It is understood that the descriptions above are only embodiments of the present disclosure. It is not intended to limit the scope of the present disclosure. Any equivalent transformation in structure and/or in scheme referring to the instruction and the accompanying drawings of the present disclosure, and direct or indirect application in other related technical field, are included within the scope of the present disclosure.

What is claimed is:

1. A storage device, comprising:
program data stored in the storage device, wherein the program data is configured to be executed to perform operations comprising:
acquiring fingerprints of two fingers of a user in advance, by fingerprint recognition buttons on both sides of a mobile terminal, and generating a verification data template of the two fingerprints according to a preset algorithm;
when the mobile terminal operates fingerprint recognition and receives an instruction of a fingerprint verification operation, acquiring fingerprints of two fingers of a user, and generating a data template according to the preset algorithm;
matching the data template with the verification data template, and when the matching is successful, prompting information that the fingerprint verification operation is passed and executing the corresponding operation instructions;
wherein
the fingerprints acquired by the fingerprint recognition buttons are different.

2. The storage device according to claim 1, wherein
the program data is configured to be executed to perform operations comprising:
when the matching the data template with the verification data template is failed, prompting information to the user that the fingerprint verification operation is failure, and prompting information to the user to input the fingerprint again for the fingerprint verification operation.

3. The storage device according to claim 2, wherein
the program data is further configured to be executed to perform operations comprising:
when the mobile terminal detects that a number that the fingerprint verification operation of the user is failed reaches a preset number, disabling current operations for a preset time, and operating again the fingerprint recognition after the preset time.

4. The storage device according to claim 1, wherein
the acquiring the fingerprints of two fingers of the user in advance by fingerprint recognition buttons on the both sides of the mobile terminal and generating the verification data template of the two fingerprints according to the preset algorithm, further comprises:
acquiring the fingerprints of two fingers of the user respectively by a fingerprint recognition button X and a fingerprint recognition button Y on the both sides of the mobile terminal;
generating a verification data template XY of the two fingerprints according to the acquired fingerprints of two fingers by a preset algorithm F, and storing the verification data template XY in a memory of the mobile terminal, wherein the verification data template XY is configured to match for the fingerprint recognition.

5. The storage device according to claim 4, wherein
the acquiring the fingerprints of two fingers of the user and generating the data template according to the preset algorithm, further comprises:
starting a verification operation target configured to operate the fingerprint recognition in the mobile terminal in advance, and prompting information to the user to input fingerprints when the operation target is performed;
when the instruction of the fingerprint verification operation is received, acquiring the fingerprints of two fingers input by the user;
generating a data template X1Y1 from the acquired fingerprints X1 and Y1 of two fingers according to the preset algorithm F.

6. The storage device according to claim 5, wherein
the instruction of the fingerprint verification operation comprises mobile terminal unlocking, application unlocking, and electronic payment verification.

7. The storage device according to claim 5, wherein
the matching the data template with the verification data template, and when the matching is successful, prompting the information that the fingerprint verification operation is passed and executing the corresponding operation instructions, further comprises:
matching the data template X1Y1 generated by the preset algorithm F, with the verification data template XY;
when the matching is successful, prompting information that the fingerprint verification operation is passed and executing the corresponding operation instructions of the user.

8. The storage device according to claim 1, wherein
when the data template is matched with the verification data template, just in case where the fingerprint recognition on both sides of the mobile terminal is passed, indicating that the fingerprint verification operation is passed.

9. A verification method based on double fingerprint recognition, comprising:
acquiring fingerprints of two fingers of a user in advance, by fingerprint recognition buttons on both sides of a mobile terminal, and generating a verification data template of the two fingerprints according to a preset algorithm;
when the mobile terminal operates fingerprint recognition and receives an instruction of a fingerprint verification operation, acquiring fingerprints of two fingers of a user, and generating a data template according to the preset algorithm;
matching the data template with the verification data template, and when the matching is successful, prompting information that the fingerprint verification operation is passed and executing the corresponding operation instructions.

10. The verification method based on double fingerprint recognition according to claim 9, wherein
the matching the data template with the verification data template, and when the matching is successful, prompting the information that the fingerprint verification operation is passed and executing the corresponding operation instructions, further comprises:
when the matching the data template with the verification data template is failed, prompting information to the user that the fingerprint verification operation is failure, and prompting information to the user to input the fingerprint again for the fingerprint verification operation.

11. The verification method based on double fingerprint recognition according to claim 10, wherein
when the mobile terminal detects that a number that the fingerprint verification operation of the user is failed reaches a preset number, disabling current operations for a preset time, and operating again the fingerprint recognition after the preset time.

12. The verification method based on double fingerprint recognition according to claim 9, wherein
the acquiring the fingerprints of two fingers of the user in advance by fingerprint recognition buttons on the both sides of the mobile terminal and generating the verification data template of the two fingerprints according to the preset algorithm, further comprises:
acquiring the fingerprints of two fingers of the user respectively by a fingerprint recognition button X and a fingerprint recognition button Y on the both sides of the mobile terminal;
generating a verification data template XY of the two fingerprints according to the acquired fingerprints of two fingers by a preset algorithm F, and storing the verification data template XY in a memory of the mobile terminal, wherein the verification data template XY is configured to match for the fingerprint recognition.

13. The verification method based on double fingerprint recognition according to claim 12, wherein
the acquiring the fingerprints of two fingers of the user and generating the data template according to the preset algorithm, further comprises:
starting a verification operation target configured to operate the fingerprint recognition in the mobile terminal in advance, and prompting information to the user to input fingerprints when the operation target is performed;
when the instruction of the fingerprint verification operation is received, acquiring the fingerprints of two fingers input by the user;
generating a data template X1Y1 from the acquired fingerprints X1 and Y1 of two fingers according to the preset algorithm F.

14. The verification method based on double fingerprint recognition according to claim 13, wherein
the instruction of the fingerprint verification operation comprises mobile terminal unlocking, application unlocking, and electronic payment verification.

15. The verification method based on double fingerprint recognition according to claim 13, wherein
the matching the data template with the verification data template and when the matching is successful, prompting the information that the fingerprint verification operation is passed and executing the corresponding operation instructions, further comprises:
matching the data template X1Y1 generated by the preset algorithm F, with the verification data template XY;
when the matching is successful, prompting information that the fingerprint verification operation is passed and executing the corresponding operation instructions of the user.

16. The verification method based on double fingerprint recognition according to claim 9, wherein
when the data template is matched with the verification data template, just in case where the fingerprint recognition on both sides of the mobile terminal is passed, indicating that the fingerprint verification operation is passed.

17. A mobile terminal, comprising:
fingerprint recognition buttons on both sides of the mobile terminal, configured to acquire and identify fingerprints of two fingers of a user;
a processor; and
a memory communicatively coupled to the processor;
wherein
the memory stores a computer program; and the processor is configured to invoke the computer program in the memory to perform operations comprising:
acquiring fingerprints of two fingers of a user in advance, by the fingerprint recognition buttons on the both sides of the mobile terminal, and generating a verification data template of the two fingerprints according to a preset algorithm;
when the mobile terminal operates fingerprint recognition and receives an instruction of a fingerprint verification operation, acquiring fingerprints of two fingers of a user, and generating a data template according to the preset algorithm;
matching the data template with the verification data template, and when the matching is successful, prompting information that the fingerprint verification operation is passed and executing the corresponding operation instructions.

18. The mobile terminal according to claim 17, further comprising:
a communication interface;
and a bus;
wherein
the processor, the memory, and the communication interface complete communications with each other through the bus; and
the communication interface is configured to transmit information between communication devices of the mobile terminal.

19. The mobile terminal according to claim 17, wherein
the processor is further configured to invoke the computer program in the memory to perform operations comprising:
when the matching the data template with the verification data template is failed, prompting information to the user that the fingerprint verification operation is failure, and prompting information to the user to input the fingerprint again for the fingerprint verification operation.

20. The mobile terminal according to claim 19, wherein
the processor is further configured to invoke the computer program in the memory to perform operations comprising:
when the mobile terminal detects that a number that the fingerprint verification operation of the user is failed reaches a preset number, disabling current operations for a preset time, and operating again the fingerprint recognition after the preset time.
